(19) United States
(12) Patent Application Publication
(10) Pub. No.: US 2024/0119785 A1
(43) Pub. Date: Apr. 11, 2024

(54) GAMING MACHINE CANDLE APPARATUSES AND METHODS

(71) Applicant: Everi Games Inc., Austin, TX (US)

(72) Inventors: Henry McDonald, Austin, TX (US); Daniel Gibson, Austin, TX (US); Garrett Mancillas, Austin, TX (US); Keith Scott McSorley, Austin, TX (US); Travis Bussey, Austin, TX (US)

(73) Assignee: Everi Games Inc., Austin, TX (US)

(21) Appl. No.: 18/223,093

(22) Filed: Jul. 18, 2023

Related U.S. Application Data
(60) Provisional application No. 63/414,892, filed on Oct. 10, 2022.

(51) Int. Cl. G07F 17/32; F21V 23/00; F21V 33/00

(52) U.S. Cl. CPC G07F 17/3216; F21V 23/004; F21V 33/008; G07F 17/3211; G07F 17/3223

(57) ABSTRACT

A gaming machine candle system includes a display device, a number of candle light-emitting elements, and a candle control system. The display device has a display device front surface and defines a display area aligned with at least a portion of the display device front surface. The candle light-emitting elements are located in an upper peripheral area of the display device and are configured to emit light through the display device front surface. The candle control system is operatively connected to control the candle light-emitting elements.

### CROSS-REFERENCE TO RELATED APPLICATION

Applicant claims the benefit, under 35 U.S.C. § 119(e), of U.S. Provisional Patent Application No. 63/414,892 filed Oct. 10, 2022, and entitled “Gaming Machine Candle Apparatuses and Methods.” The entire content of this provisional application is incorporated herein by this reference.

### TECHNICAL FIELD OF THE INVENTION

The invention relates to gaming machines and more particularly to the candle of a gaming machine. The present invention includes a candle system for gaming machines, gaming machines incorporating such a candle system, and methods for providing candle functions at a gaming machine.

### BACKGROUND

Gaming machines such as mechanical and video reel-type gaming machines, video poker gaming machines, and other types of gaming machines commonly include a lighting device referred to as a “candle” that is traditionally mounted at the top of the gaming machine cabinet. Traditional gaming machine candles have a cylindrical lighting fixture with two or three different light segments, each having a different colored lens and adapted to be controlled independently. The functions that may be provided by a gaming machine candle include indicating the denomination of the gaming machine, signaling to casino staff when there is a malfunction or other problem at the gaming machine, and signaling to casino staff when a special payout is required at the gaming machine. These functions are all provided through the candle by the state of the lighting elements in the fixture in terms of color and/or lighting pattern (solid, slow flashing, rapid flashing).

### SUMMARY OF THE INVENTION

Objects of the invention include providing gaming machine candle systems that do not require a separate lighting fixture mounted at the top of the gaming machine cabinet (for example) and also include providing gaming machines incorporating such a candle system. Other objects of the invention include providing methods for facilitating candle functions at a gaming machine.

A gaming machine candle system according to a first aspect of the invention comprises a display device-integrated candle system. Such a system includes a display device, a number of candle light-emitting elements, and a candle control system. The display device has a display device front surface and defines a display area aligned with at least a portion of the display device front surface. The candle light-emitting elements are located in a peripheral area of the display device, such as an upper peripheral area for example, and are configured to emit light through the display device front surface. The candle control system is operatively connected to control the candle light-emitting elements to provide the desired candle light functions.

As used in this disclosure and the accompanying claims, “operatively connected” means a connection that provides necessary operating power and allows the connected elements to perform their function in the apparatus or method. In the case of the candle control system for example, the system is connected to the candle light-emitting elements to provide operating power to the candle light-emitting elements. An “operative connection” between processing devices or controllers comprises a connection that facilitates data and control communications between the devices.

A gaming machine candle system in accordance with the first aspect of the invention has the advantage that it does not require a separate lighting fixture mounted on the gaming machine cabinet or related structure. Rather, the candle light-emitting elements, that is, the lighting elements that emit light to provide the candle functions, are incorporated in a display device of the gaming machine. This arrangement may save costs and may also be more aesthetically pleasing. This arrangement may also facilitate accent lighting effects not possible with a separate lighting fixture mounted atop the gaming machine.

A second aspect of the invention comprises a gaming machine incorporating candle system in accordance with the first aspect. Such a gaming machine includes a gaming machine cabinet and a game processing system in addition to the above-described display device, candle light-emitting elements, and candle control system.

In some implementations in accordance with the first and second aspects of the invention the candle light-emitting elements may comprise LEDs, particularly RGB LEDs. In these implementations the candle light-emitting elements may be separate from a video display monitor included in the display device for displaying game play related graphics or accent graphics. Other implementations according to the first and second aspects of the invention include candle light-emitting elements comprising pixels of a video display monitor included in the display device. In these latter implementations, a portion of the video area provided by the video display monitor may be controlled to provide the candle functions for the gaming machine. It will be noted here that the designation “candle light-emitting element” as used in this disclosure and accompanying claims refers to discrete light emitting devices such as LEDs or other types of light emitting devices and also one or more pixels of a video display device that may or may not emit light directly. For example, pixels of an OLED display could comprise candle light-emitting elements that emit light directly, while pixels of an LCD display pass light emitted by a back light of the display. In the latter case, the pixels of the LCD display combine with the back light of the display to emit light of the desired intensity, pattern, and color.

In accordance with either the first or second aspect of the invention where the candle light-emitting elements are LEDs or similar light emitting devices, the candle control system may include driver circuits and a candle controller. The driver circuits in these implementations may be operatively connected to supply a respective driving signal to each of the candle light-emitting elements. The candle controller in these implementations may be operatively connected to the driver circuits and adapted to be operatively connected to a game processing system of the gaming machine.

The display device of implementations according to either the first or second aspects may include a housing defining a display device volume with a video display monitor mounted within the display device volume. An elongated light-emitting element circuit board in these implementations may be mounted in the display device volume between an upper side of the housing and an upper edge of the video display monitor. The candle light-emitting elements may be mounted on the elongated light-emitting element circuit board. In some implementations the elongated light-emitting element circuit board or a second elongated light-emitting element circuit board may extend within the display device volume between the first candle light-emitting elements and the upper edge of the video display monitor.

In some implementations, the elongated light-emitting element circuit board may include a center light-emitting element area flanked by a right-side light-emitting element area and a left-side light emitting element area. In these embodiments the candle light-emitting elements may be located in the center light-emitting element area, while accent light-emitting elements are located in each of the right-side light-emitting element area and the left-side light-emitting element area. These accent light-emitting elements may be configured to emit light through the display device front surface under the control of the same controller that controls the operation of the candle light-emitting elements. Alternatively, these flanking accent light-emitting elements may operate under a different controller, distinct from the controller that controls the operation of the candle-light emitting elements.

A third aspect of the invention encompasses methods for providing gaming machine candle functions at a gaming machine. Methods according to this third aspect include receiving a candle illumination state signal that defines a candle illumination state and driving a number of candle light-emitting elements in accordance with the candle illumination state. The candle light-emitting elements are located in a display device as described above in connection with the first aspect of the invention. Driving the candle light-emitting elements causes these elements to emit light through the display device front surface to provide the candle function. The candle illumination state will typically define an illumination color for at least two different adjacent subsets of the candle light-emitting elements as well as an illumination effect or pattern either solid on or flashing on and off at some predefined rate.

Methods according to this third aspect may further include, simultaneously with driving the number of candle light-emitting elements, driving the display device to generate game graphics in at least a portion of the display area.

Where the candle light-emitting elements are LEDs, driving the candle light-emitting elements includes directing a respective driving signal to each candle light-emitting element under control of a controller operatively connected to a game processing system of the gaming machine. For RGB LEDS, the respective driving signal is made up of separate R, G, and B signals each applied along a suitable signal path.

Where each candle light-emitting element includes a respective pixel of a video display monitor included in the display device, driving the candle light-emitting elements includes directing a video signal to the video display monitor. This is in contrast to the LED arrangement, where the driving signal is applied through an LED controller and LED driver.

These and other aspects, advantages, and features of the invention will be apparent from the following description of representative embodiments, considered along with the accompanying drawings.

### BRIEF DESCRIPTION OF THE DRAWINGS

FIG. 1 is an isometric view of a gaming machine that may be used for some implementations of the present invention.

FIG. 2 is a block diagram showing the various components that may be included in the gaming machine shown in FIG. 1.

FIG. 3 is a block diagram of a gaming system including gaming machines such as that shown in FIG. 1.

FIG. 4 is an isometric view of the uppermost display device shown in FIG. 1 in section taken along line 4-4 in FIG. 1.

FIG. 5 is a front view of the uppermost display device shown in FIG. 1 with the front cover glass and peripheral diffuser removed.

FIG. 6 is an enlarged isometric view of the area called out in FIG. 5.

FIG. 7 is a flow chart showing a process for detecting a display device-integrated candle and then either controlling that integrated candle in accordance with aspects of the present invention or controlling a separate candle mounted on the gaming machine.

FIG. 8 is a schematic representation of a portion of a gaming machine video display device configured to provide candle functions in accordance with aspects of the invention.

### DESCRIPTION OF REPRESENTATIVE EMBODIMENTS

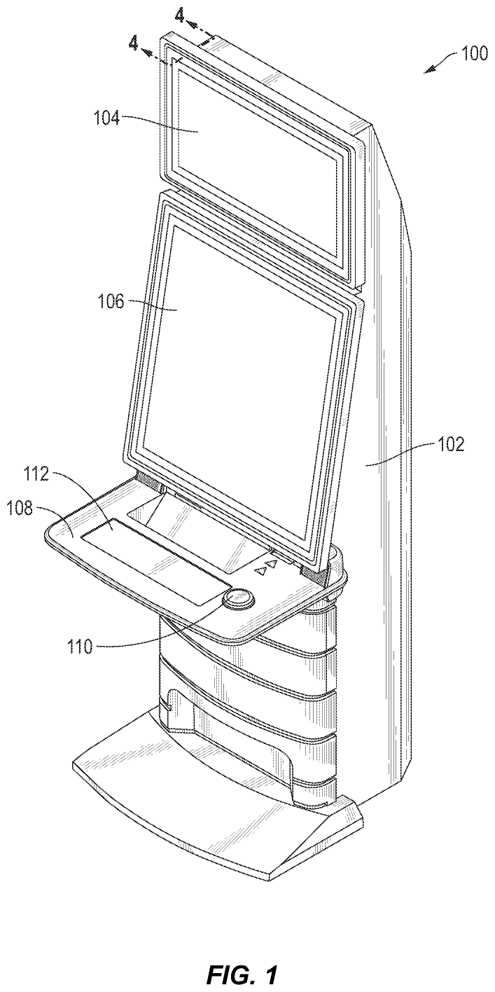

Referring to FIG. 1, gaming machine 100 includes a cabinet 102 that houses various elements of the gaming machine. A front side of cabinet 102 supports an upper display device 104 and a lower display device 106. The front side of cabinet 102 also supports a button deck 108 that contains various player controls and interface devices including play button 110 and a touch screen button panel 112.

It will be appreciated that gaming machines may also include a number of other player interface devices in addition to devices that are considered player controls for use in entering inputs in the course of a particular game. For example, gaming machine 100 may include a currency/voucher acceptor, a voucher/receipt printer having a voucher/receipt printer, and a player card reader although these elements are not called out in FIG. 1. Numerous other types of player interface devices may be included in gaming machines used to implement embodiments of the present invention.

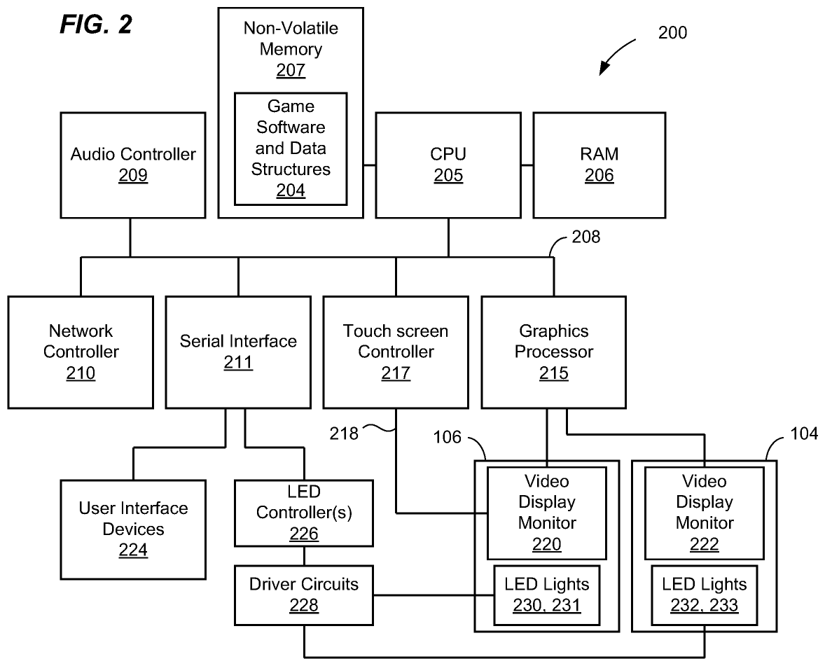

FIG. 2 shows a logical and hardware block diagram 200 of gaming machine 100 that includes a processor (CPU) 205 along with random access memory (RAM) 206 and nonvolatile memory or storage device 207. Processor 205 is connected on a system bus 208 with an audio controller 209, a network controller 210, and a serial interface 211. A graphics processor 215 is also connected on bus 208 and is connected to drive a video display monitor 220 included in display device 106 and a video display monitor 222 included in display device 104 (104 and 106 also shown in FIG. 1). Graphis processor 215, or another graphics processor included in the gaming machine but not shown in this diagram, may also provide a suitable video output to other video display devices included on the gaming machine such as touch screen button panel 112 for example. As shown in FIG. 2, gaming machine 100 also includes a touch screen controller 217 connected to system bus 208. Touch screen controller 217 is also connected via signal path 218 to receive signals from a touch screen element associated with video display monitor 220 (and also potentially a touch screen element associated with button panel 112 although not shown in FIG. 2). It will be appreciated that the touch screen element itself typically comprises a thin film secured over a surface of the respective display device. The touch screen element itself is thus not illustrated or referenced separately in the figures. The present invention is not limited to any particular touch screen technology.

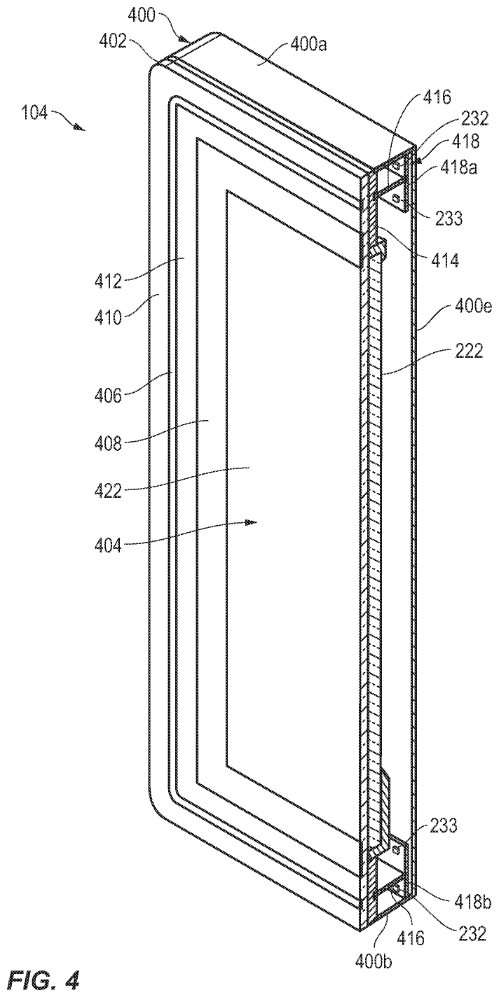

FIG. 2 shows that gaming machine 100 also has a candle control system including LED controllers 226 connected for serial communications through serial interface 211. Each LED controller 226 is operatively connected to driver circuits 228 that are each connected to apply LED driving signals to a respective LED light associated with one of the display devices 104 and 106. Namely, some of driver circuits 228 are connected to apply driving signals to LED lights 230 associated with display device 106 and other of the driver circuits 228 are connected to apply diving signals to LED lights 231 associated with display device 106. Similarly, LED driver circuits 228 include circuits connected to apply driving signals to LED lights 232 associated with display device 104 and other driver circuits connected to apply driving signals to LED lights 233 associated with display device 104. As will be described further below in connection with FIGS. 4-6, LED lights 232 may be used to provide candle functions in accordance with aspects of the present invention. LED lights 230, 231, 232 and 233 may also be used to provide accent lighting for the respective video display monitor 220 and 222.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer, although they may be specially designed and configured for use in a gaming environment. In particular, the processing devices such as CPU 205 may be configured as special purpose processing devices with security features to meet gaming regulatory requirements and allow for operation in a gaming environment. The various elements shown connected on system bus 208 in FIG. 2 may be mounted on (or connected to) a motherboard and housed in an enclosure that itself may be mounted in cabinet 102 shown in FIG. 1. Alternatively, the various electronic components may be mounted on one or more circuit boards housed within cabinet 102 without a separate enclosure. Those familiar with data processing systems and the various data processing elements shown in FIG. 2 will appreciate that many variations on this illustrated structure may be used within the scope of the present invention. For example, since serial communications are commonly employed to communicate with a touch-screen controller such as touch screen controller 217, the touch screen controller may not be connected on system bus 208, but instead include a serial communications link to serial interface 211 (a USB controller for example). It will also be appreciated that some of the devices shown in FIG. 2 as being connected directly on system bus 208 may in fact communicate with the other system components through a suitable expansion bus. Audio controller 209, for example, may be connected to the system via a PCI or PCIe bus or bus configured according to some other expansion bus standard. System bus 208 is shown in FIG. 2 merely to indicate that the various components are connected in some fashion for communication with CPU 205 and is not intended to limit the invention to any particular bus architecture.

Numerous other variations in the gaming machine internal structure and system may be used without departing from the principles of the present invention. For example, a gaming machine in some embodiments of the present invention may rely on one or more data processors located remotely from the gaming machine itself. Embodiments of the present invention may include no processor such as CPU 205 or graphics processor such as 215 at the gaming machine, and may instead rely on one or more remote processors. Thus unless specifically stated otherwise, the designation “gaming machine” is used in this disclosure and the accompanying claims to designate a system of devices that operate together to provide the indicated functions. A “gaming machine” may include a gaming machine such as gaming machine 100 shown in FIGS. 1 and 2, that is itself a system of various components, and may also include one or more components remote from a gaming machine cabinet (that is, cabinet 102 in FIG. 1). As used herein, the designation “gaming machine” encompasses both a stand-alone gaming machine and a gaming machine (that is, the part housed in a cabinet such as cabinet 102 in FIG. 1) along with one or more remote components for providing various functions.

Although separate graphics processor 215 is shown for controlling video display monitors 220 and 222, CPU 205 or a graphics processor packaged with or included with CPU 205 may control all of the video display devices directly without any separately packaged graphics processor. The invention is not limited to any particular arrangement of processing devices for controlling the video display monitors included with gaming machine 100. Also, a gaming machine implementing the present invention is not limited to any particular number of video display monitors or other types of display devices.

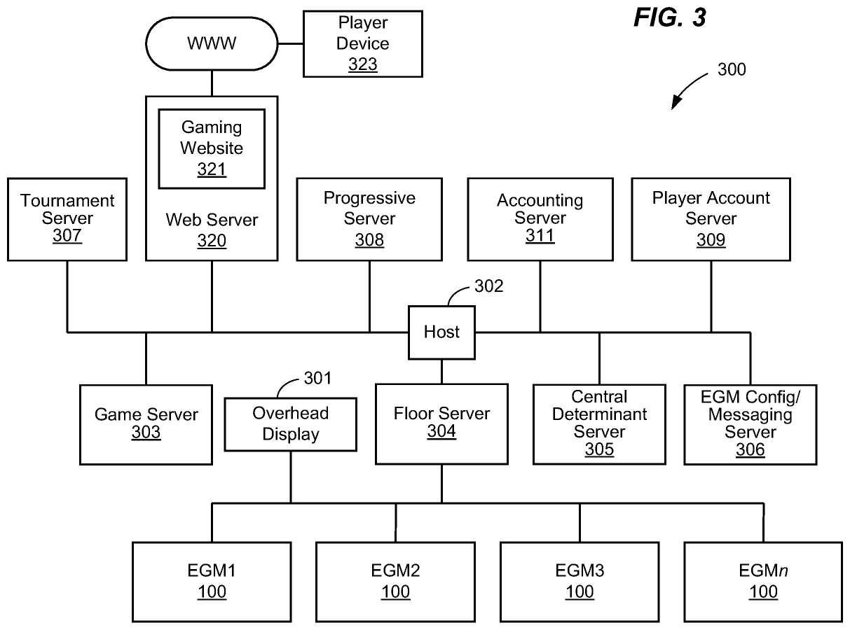

In the illustrated gaming machine 100, CPU 205 executes game and other software 204, that is, program code, to function as a game processing system that ultimately controls the entire gaming machine including the receipt of player inputs and the presentation of the graphics or information displayed according to the invention through the display devices 104 and 106 associated with the gaming machine. In particular, CPU 205 may execute candle function software that causes instructions to be communicated to each LED controller 226 for providing candle functions. CPU 205 also executes software related to communications handled through network controller 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software (program code) prior to loading into random access memory 206 for execution, or for programs and program assets not in use or for other data generated or used in the course of gaming machine operation. Network controller 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which the invention may be implemented may include one or more special purpose processing devices that together represent a game processing system that does not employ operational program code to direct the various processing steps.

The example gaming machine 100 is shown in FIG. 2 as including user interface devices 224 (part of a player input system) connected to serial interface 211. These user interface devices may include various player input devices such as play button 110 in FIG. 1 and other mechanical buttons, virtual buttons shown on touchscreen button panel 112 in FIG. 1, and/or levers, and other devices. It will be appreciated that the interface between CPU 205 and other player input devices such as player card readers, voucher readers or printers, and other devices may be in the form of serial communications. Thus serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Referring now to FIG. 3, a networked gaming system 300 associated with one or more gaming facilities may include one or more networked gaming machines 100 (shown in FIG. 3 as EGM1-EGMn) connected in the network by suitable network cable or wirelessly. Networked gaming machines 100 and one or more overhead display devices 301 may be operatively connected so that the overhead display device or display devices may mirror or replay the content of one or more displays of gaming machines 100. For example, the display content for a given gaming machine 100 (including a base game portion and/or bonus features) may be transmitted through network controller 210 to a controller associated with the overhead display device(s) 301. In the event gaming machines 100 have cameras installed, the respective player's video images may be displayed on overhead display device 301 along with the content of the player's gaming machine display.

The example gaming network 300 shown in FIG. 3 includes a host server 302 and floor server 304, that together may function as an intermediary between floor devices such as gaming machines 100 and back-office devices such as the various servers described below. Game server 303 may provide server-based games and/or game services to network connected gaming devices such as gaming machines 100. Central determinant server 305 may be included in the network to identify or select lottery, bingo, or other centrally determined game results and provide the result information to networked gaming machines 100 that present the games or game results to players.

EGM configuration and messaging server 306 may provide game and non-game content and operational software for use by the gaming machines 100 in the course of providing games and while the gaming machines are unused and in an idle state. For example, server 306 may control the distribution of game software and graphic control assets to the gaming machines as well as advertising messages and other messages that may be presented using a display device of a gaming machine 100. EGM configuration and messaging server 306 may also be used to direct candle control software to gaming machines 100 that include a display device-integrated candle system in accordance with aspects of the present invention.

Tournament server 307 may be included in the system for controlling or coordinating tournament functions. These functions may include maintaining tournament player scores and ranking during the course of tournament play, and communicating this information to the various gaming machines 100 participating in the tournament. Tournament server 307 may also function to enroll players in tournaments, schedule tournaments, and maintain the time remaining in the various tournaments.

Progressive server 308 may maintain progressive pools for progressive games that may be available through the various gaming machines 100. In some implementations, progressive server 308 may simply receive communications indicating contribution amounts that have been determined by processes executing at the various gaming machines 100 or elsewhere in the gaming network. Alternatively, progressive server 308 may perform processes to determine the contribution amounts for incrementing the various progressive pools that may be maintained. Progressive server 308 may also periodically communicate current pool values back to the various gaming machines 100 and may participate in communicating awarded progressive prize amounts to the gaming machines and in adjusting the progressive prize pools accordingly. In some implementations, progressive server 308 may also determine or participate in determining when a progressive prize triggering event occurs.

Accounting server 311 may receive gaming data from each of the networked gaming devices, perform audit functions, and provide data for analytical programs. Player account server 309 may maintain player account records, and store persistent player data such as accumulated player points and/or player preferences (for example, game personalizing selections or options).

Example gaming network 300 also includes a gaming website 321 that may be hosted through web server 320 and may be accessible by players via the Internet. One or more games may be displayed and played by a player through a player device 323 such as a wired or wireless personal computer or handheld wireless device (for example, an Android® operating system smart phone, Apple® iPhone® smart phone, personal digital assistant (PDA), iPad® or other tablet computer, etc.). To enter website 321, a player may log in with a user name that may, for example, be associated with the player's account information stored on player account server 309. Once logged in to website 321 the player may play various games on the website. Also, website 321 may allow the player to make various personalizing selections and save the information so it is available for use during the player's next gaming session at a casino establishment having the gaming machines 100.

Gaming network 300 illustrated in FIG. 3 is provided merely as an example of a gaming network that may include gaming machines with candle systems according to aspects of the present invention and is not intended to be limiting in any way. Gaming machines controlled according to aspects of the present invention are not limited to use with gaming networks such as network 300.

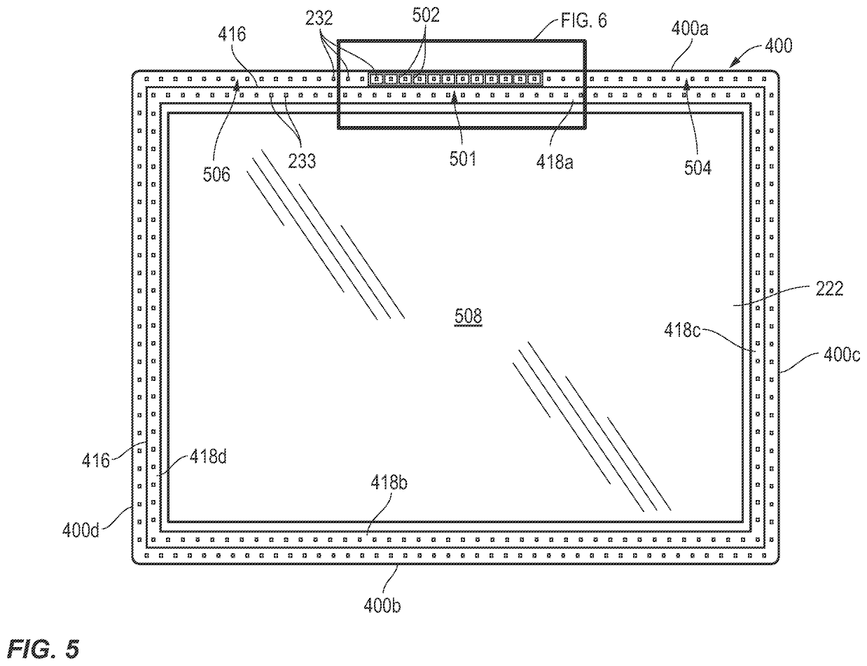

FIG. 4 shows an enlarged section view taken along a vertical plane indicated by line 4-4 through upper display device 104 shown in FIG. 1. Upper display device 104 in this illustrated implementation includes a housing 400 defining a display device volume bounded by a housing upper side 400a, lower side 400b, right side 400c (shown in FIG. 5), left side 400d (also shown in FIG. 5), and back panel 400e. Upper display device 104 also includes a front cover 402 that defines a front surface 404 of the display device. In the implementation shown in FIG. 4, areas of an opaque coating are located on front surface 404 for purposes that will be described further below. The areas of opaque coating include an outer opaque coating area 406 and an inner opaque coating area 408. Outer clear (transparent) area 410 remains on front cover 402 along with an inner clear area 412 and a central clear area 422. Although the entire ring of material is not shown in the section view of FIG. 4, it will be appreciated that opaque coating areas 406 and 408, and clear areas 410 and 412 each form a ring that extends around the entire peripheral area of front cover 402 as is apparent from FIG. 1.

The section view of FIG. 4 also shows that upper display device 104 includes a diffuser 414. In this example, diffuser 414 comprises a ring of diffuser material captured between the front edge of housing 400 and the back side of front cover 402. Diffuser 414 extends in a ring around the entire peripheral area of front cover 402 and is positioned to align with the clear areas 410 and 412. An accent light divider 416 is included in display device 104 behind diffuser 414. In this example, accent light divider 416 extends forwardly from a printed circuit board 418. Although not shown in the drawings, accent light divider 416 may be connected to circuit board 418 with a suitable flange on the accent light divider 416 or may be held in the illustrated position in any suitable fashion. As shown best in FIG. 5 in which the front cover 402 and diffuser 414 are removed, both accent light divider 416 and print circuit board 418 extend around the entire peripheral area of housing 400 to form an overall rectangular ring shape. Although producing an overall rectangular ring shape, printed circuit board 418 may be conveniently formed in four elongated, interconnected sections each defining a side of the ring shape. The example implementation shown in FIG. 5 includes an elongated circuit board upper section 418a, an elongated circuit board lower section 418b, an elongated circuit board right section 418c, and an elongated circuit board left section 418d. Both FIGS. 4 and 5 show that within the area bounded by printed circuit board 418 resides the video display monitor 222 shown also in the block diagram of FIG. 2.

FIG. 5 shows a number of individual LEDs mounted in rows on printed circuit board 418. In particular, LEDs 232 are arranged in an outer ring to the outside of light divider 416 (with respect to a center of display device 104) and LEDs 233 are arranged in an inner ring to the inside of light divider 416. Although not shown in the drawings, it will be appreciated that printed circuit board 418 includes separate conductor traces for supplying driving signals to each of the LEDs 232 and 233. From the view of FIG. 5 as compared to the view of FIG. 4, it will be apparent that the front surface 508 of video display monitor 222 is located in housing 104 to align generally with the central clear area 422 of cover 402 shown in FIG. 4. FIGS. 4 and 5 taken together also show that the inner ring of LEDs 233 aligns with inner clear ring 412 of front cover 402 and the outer ring of LEDs 232 aligns with outer clear area 410 of front cover 402. This alignment of the LEDs 232 and 233 together with the opaque areas 406 and 408 on front cover 402 and light baffle element 416b allow the LEDs 232 and 233 to be operated to provide rings of accent lighting around the area of video display monitor 222 behind central clear area 422 of front cover 402.

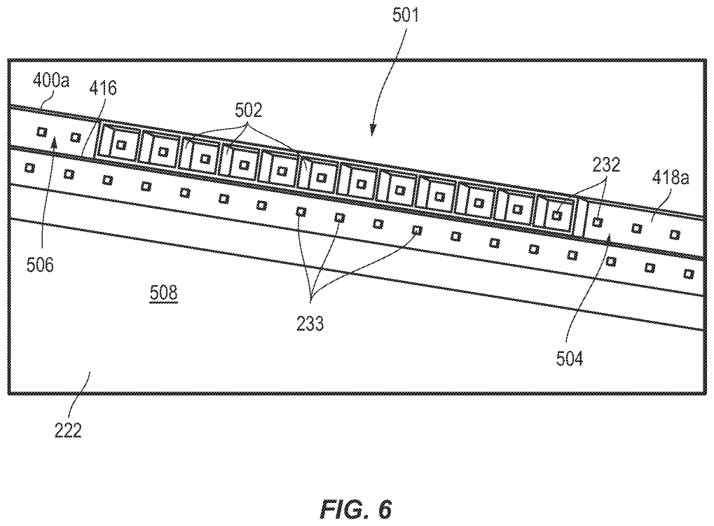

Referring now to FIG. 5 and the enlarged view of FIG. 6, a central area 501 of the printed circuit board upper part 418a includes a series of vertical light baffles 502 spaced apart so as to flank each of the LEDs 232 in that central area with each LED in that area centered between adjacent baffles 502 and centered vertically on printed circuit board upper part 418a above light divider 416. In this example, the light baffles 502 isolate twelve LEDs 232 of the LED outer ring to help direct light from those LEDs 232 forwardly and minimize mixing of light from adjacent isolated LEDs 232. The outer ring of LEDs 232 form a right accent area 504 to the right of the central area 501 and form a left accent area 506 to the left of the central area 501. The central area 501, right accent area 504, and left accent area 506 are each located in an upper peripheral area of the display device 104.

The operation of display device 104 to provide candle functions at gaming machine 100 shown in FIG. 1 may now be described with reference to FIGS. 2 and 4 through 6. In response to receiving a candle illumination state signal, the candle light-emitting elements represented by LEDs 232 between the light baffles 502 (FIGS. 5 and 6) are driven in accordance with an illumination state defined by the candle illumination state signal. For example, game processor 205 may transmit a candle illumination state signal to LED controller 226. LED controller 226 functions as a candle controller and responds to this candle illumination state signal to cause driver circuits 228 to direct suitable LED driving signals to the LEDs 232 between baffles 502. The collection of twelve candle light-emitting elements defined by LEDs 232 between baffles 502 may be divided in any suitable fashion to provide the candle function. Commonly the twelve LEDs 232 between baffles 502 will be driven in two or three adjacent sets to provide two or three candle segments (that is, segments of illumination color and flashing or solid on state). The arrangement of twelve LEDs 232 provides the advantage that the LEDs may be controlled to provide two candle segments of equal length, three candle segments of equal length, four candle segments of equal length, or even six candle segments of equal length. Regardless of how the LEDs 232 between light baffles 502 are driven, the LEDs are configured to emit light in an area of the display device front surface defined by front cover 402 shown in FIG. 4, particularly in the central area 501 shown in FIG. 5. Simultaneously with driving the LEDs 232 comprising the candle light-emitting elements in this embodiment, the video display monitor 222 is driven by a suitable video signal provided through the gaming machine (such as through graphics processor 215 in FIG. 2) to generate game-related graphics in at least a portion of the video display area defined by central area 422 of cover 402 as shown in FIG. 4. It will be appreciated that driving the LEDs 232 representing the candle light-emitting elements in this example embodiment includes applying a suitable driving signal from a respective driver circuit arrangement (228 in FIG. 2) to each of the LEDs. In the event LEDs 232 comprise RGB LEDs, the driving signal includes three separate signals each provided through a respective drive circuit to separately drive the three different color elements of the respective LED 232 to provide the desired segment color, such as red, white, or blue, for example.

The remainder of the outer ring LEDs 232 and all of the inner ring LEDs 233 may be driven to provide various accent lighting effects for the gaming machine. These accent lighting effects may include flashing effects in different colors, chasing effects in different colors around the rings and many other types of lighting effects that may be coordinated with game play or independent of game play. In some implementations, LEDs 232 between light baffles 502 making up the candle light-emitting elements may be periodically used to also provide accent lighting effects and then switched back to provide the candle function as desired. Alternatively, LEDs 232 between light baffles 502 may be used exclusively for providing the candle function. In either case, all of the outer ring LEDs 232 (those between baffles 502 and those in other areas of the outer ring) and all of the inner ring LEDs 233, may be driven by a respective driver circuit 228 under control of the same controller 226, both shown in FIG. 2. In some implementations it may be desirable to include multiple controllers 226 to control the LEDs 232 and 233. For example, where different circuit boards such as boards 418a, 418b, 418c, and 418d in FIG. 5 form the rectangular arrangement of LEDs 232 and 233, each board may carry at least one controller 226 together with driver circuits 228 for operating the LEDs 232 and 233 on that respective circuit board.

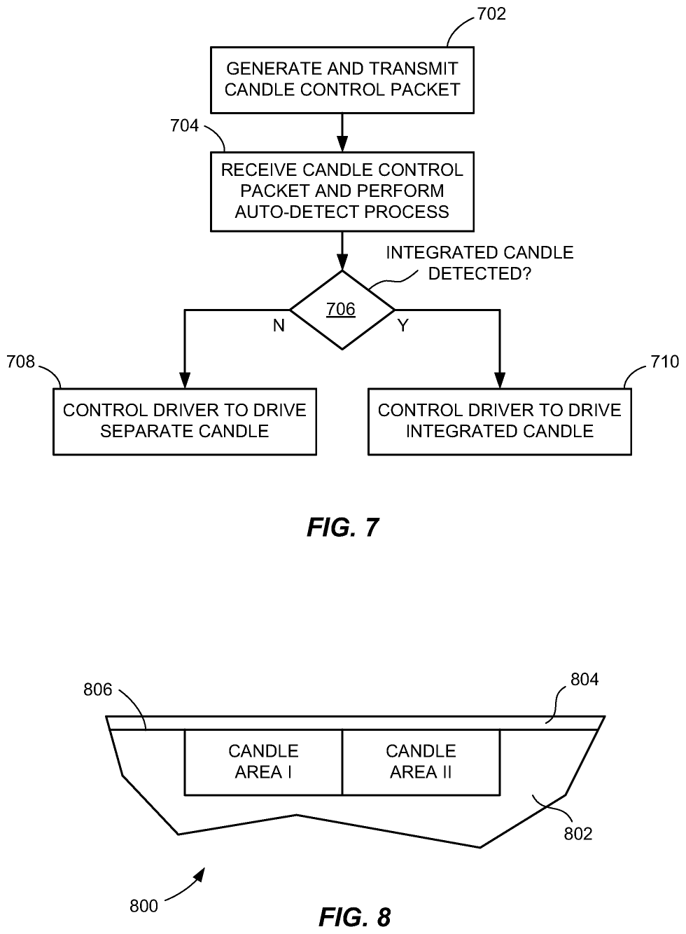

Some implementations of the present invention may include an auto-detection arrangement for detecting whether the gaming machine is configured to provide the candle function through a display device-integrated candle as described herein or a separate candle (for example, one housed in a separate housing atop the gaming machine cabinet). An auto-detection process is shown for example in FIG. 7. The process includes producing a candle control packet of information and transmitting that packet to the candle controller(s) as shown at 702 in FIG. 7. In example gaming machine 100 shown in FIGS. 1 and 2, game processor 205 may generate the candle control packet and cause that packet of data to be transmitted to controller(s) 226. The packet of data comprises the candle illumination state signal and will define a candle illumination state. As shown at process block 704, the controller(s) receive the candle control packet and conduct an auto-detect process to determine whether the gaming machine includes a display device-integrated candle. In the event the display device-integrated candle is detected at decision box 706, the controller causes the drivers (such as driver circuits 228 in FIG. 2) to direct suitable driving signals to the light-emitting elements of the display device-integrated candle (the twelve LEDs 232 in central area 501 shown in FIG. 5 of the illustrated example). If no display device-integrated candle is detected, the game processor 205 sends the candle illumination state signal to a control arrangement for the separate candle device. As an alternative to the process shown in FIG. 7, the auto detection arrangement may be configured to detect a separate candle and then, if no separate candle is detected, cause the drivers to control an integrated candle as described herein. Regardless of the logic applied in the auto-detect process, where the separate candle provides the different color candle segments via RGB LEDs, the control arrangement for the separate candle could include a controller such as controller 226 connected to driver circuits for the separate candle LEDs. Such a separate candle could include for example a separate generally cylindrical candle housing mounted on top of cabinet 102 with a vertically oriented line of RGB LEDs that may be driven to produce the desired candle color segments and any flashing pattern.

Numerous variations from the illustrated embodiment are possible within the scope of the present invention. For example, some implementations may not use light baffles 502 to isolate the LEDs 232 making up the candle light-emitting elements. Also, some implementations may use inner ring LEDs 233 in addition to or in lieu of outer ring LEDs 232 included to provide the candle functions. Light baffles similar to baffles 502 may be added to isolate inner ring LEDs 233 in a corresponding central area of that inner ring of LEDs. Embodiments may also include numerous variations on the structure of the display device with which the candle light-emitting elements are integrated. For example, although the embodiment shown in FIG. 4 includes a monolithic display device front cover 402, other embodiments may include separate front cover parts for video monitor 222 and the peripheral lighting, including the candle light-emitting elements 232. Also, some embodiments may have a housing similar to housing 104 but with a central area (corresponding to area 501) that projects upwardly above the remainder of the upper side of the housing. The candle light-emitting elements in these embodiments may include light-emitting elements in such an upwardly projecting area of the display device housing.

It should also be noted that a gaming machine implementing candle functions in accordance with the present invention may also include mechanical reels or other mechanical devices for use in conducting games offered through the gaming machine. For example, a display device in an uppermost portion of the gaming machine cabinet may include a mechanical wheel or mechanical reels shown in a display area at least partially surrounded by peripheral candle and accent lighting similar to LEDs 232 and 233 shown in FIGS. 5 and 6. Candle functions in accordance with the present invention may be implemented with a portion of such accent lighting similarly to the candle functions described above in connection with FIGS. 4-6.

Whether the display device houses a video monitor or some other display system such as mechanical reels or wheels, implementations of a display device-integrated candle according to the present invention need not include peripheral accent lighting in addition to the candle light-emitting elements. For example, some implementations may include only one or more lines of LEDs in the central area 501 in FIG. 5, or just along the top side of the display device housing. Implementations of the display device-integrated candle are not limited to arrangements where one or more rings of light emitting elements such as LEDs extend around the entire peripheral front surface of the display device.

Other implementations within the scope of the present invention may not rely on LEDs such as LEDs 232 shown in FIGS. 4-6 to provide the candle function. These other implementations may use illumination from a portion of a video display monitor rather than separate LEDs or other separate light-emitting elements. FIG. 8 shows such an alternative arrangement for providing candle functions at a gaming machine in accordance with the present invention. FIG. 8 shows an upper portion of a video display device 800 of a gaming machine. In this example, video display device 800 includes a video display area 802 surrounded by a thin bezel, including an upper bezel 804. Upper bezel 804 defines any uppermost edge 806 of video display area 802. Video display area 802 includes to candle function areas labeled candle area I and candle area II in the figure. These two candle areas comprise areas of pixels of the video display area 802 but are used in accordance with the present invention to at least periodically provide candle functions while the remainder of video display area 802 displays game-related graphics or other graphics at the gaming machine. Thus the pixels in candle area I may be driven to show a predefined color and/or flash at a predefined rate while the pixels in candle area II may be driven to show a different predefined color and/or flash at a predefined rate to indicate a status of the gaming machine. These implementations using a peripheral area of a gaming machine video display device control the candle functions with the video signal directed to the display device and thus the candle control system here comprises the devices used to drive the video display device (such as CPU 205 and graphics processor 215 in FIG. 2). Such video display-implemented candles may provide any number of candle segments and any candle segment color, limited only by the capabilities of the video system.

As used herein, whether in the above description or the following claims, the terms “comprising,” “including,” “carrying,” “having,” “containing,” “involving,” and the like are to be understood to be open-ended, that is, to mean including but not limited to. Also, it should be understood that the terms “about,” “substantially,” and like terms used herein when referring to a dimension or characteristic of a component indicate that the described dimension/characteristic is not a strict boundary or parameter and does not exclude variations therefrom that are functionally similar.

Any use of ordinal terms such as “first,” “second,” “third,” etc., in the following claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements that does not have the defined characteristic or feature.

The above-described representative embodiments are intended to illustrate the principles of various embodiments, but not to limit the scope of the invention. Various other embodiments and modifications to these representative embodiments may be made by those skilled in the art without departing from the scope of the present invention. For example, in some instances, one or more features disclosed in connection with one embodiment can be used alone or in combination with one or more features of one or more other embodiments. More generally, the various features described herein may be used in any working combination.

1. A candle system for a gaming machine, the candle system including:
(a) a display device having a display device front surface and defining a display area aligned with at least a portion of the display device front surface;
(b) a number of candle light-emitting elements located in an upper peripheral area of the display device and configured to emit light through the display device front surface; and
(c) a candle control system operatively connected to control the number of candle light-emitting elements.

2. The candle system of claim 1 wherein the candle control system includes:
(a) a number of driver circuits, each driver circuit operatively connected to supply a respective driving signal to each of the candle light-emitting elements; and
(b) a candle controller operatively connected to the number of driver circuits, the candle controller being adapted to be operatively connected to a game processing system of the gaming machine.

3. The candle system of claim 2 wherein each of the number of candle light-emitting elements comprises an RGB LED and the respective driving signal to each of the light-emitting elements comprises separate R, G, and B signals.

4. The candle system of claim 2 wherein the display device includes:
(a) a housing defining a display device volume bounded by an upper side, a lower side, a right side, and a left side;
(b) a video display monitor mounted in the display device volume; and
(c) an elongated light-emitting element circuit board mounted in the display device volume between the housing upper side and an upper edge of the video display monitor, and wherein one or more of the number of the candle light-emitting elements are mounted on the elongated light-emitting element circuit board.

5. The candle system of claim 4 wherein the elongated light-emitting element circuit board extends to an area in the display device volume between the candle light-emitting elements and the upper edge of the video display monitor.

6. The candle system of claim 4 wherein:
(a) the elongated light-emitting element circuit board includes a center light-emitting element area, a right-side light-emitting element area to the right of the center light-emitting element area, and a left-side light emitting element area to the left of the center light-emitting element area;
(b) the candle light-emitting elements are located in the center light-emitting element area; and
(c) one or more accent light-emitting elements are located in each of the right-side light-emitting element area and the left-side light-emitting element area and are configured to emit light through the display device front surface.

7. The candle system of claim 6 further including a number of additional driver circuits operatively connected to supply a respective driving signal to each light-emitting element located in the right-side light-emitting element area and the left-side light-emitting element area.

8. The candle system of claim 1 wherein:
(a) the display device includes a video display monitor that defines the display area; and
(b) each candle light-emitting element includes a respective pixel of the video display monitor.

9. A gaming machine including:
(a) a gaming machine cabinet;
(b) a game processing system;
(c) a display device having a display device front surface and defining a display area aligned with at least a portion of the display device front surface, the display area comprising an uppermost game graphics display area of the gaming machine;
(d) a number of candle light-emitting elements located in an upper peripheral area of the display device in position to emit light through the display device front surface; and
(e) a candle control system operatively connected to control the number of candle light-emitting elements.

10. The gaming machine of claim 9 wherein the candle control system includes:
(a) a number of driver circuits operatively connected to supply a respective driving signal to each of the candle light-emitting elements; and
(b) a candle controller operatively connected to the number of driver circuits, the candle controller being adapted to be operatively connected to the game processing system of the gaming machine.

11. The gaming machine of claim 10 wherein each of the number of candle light-emitting elements comprises an RGB LED and the respective driving signal to each of the light-emitting elements comprises separate R, G, and B signals.

12. The gaming machine of claim 10 wherein the display device includes:
(a) a housing defining a display device volume bounded by an upper side, a lower side, a right side, and a left side;
(b) a video display monitor mounted in the display device volume; and
(c) an elongated light-emitting element circuit board mounted in the display device volume between the housing upper side and an upper edge of the video display monitor, and wherein one or more of the number of the candle light-emitting elements are mounted on the elongated light-emitting element circuit board.

13. The gaming machine of claim 12 wherein the elongated light-emitting element circuit board extends into an area of the display device volume between the candle light-emitting elements and the upper edge of the video display monitor.

14. The gaming machine of claim 12 wherein:
(a) the elongated light-emitting element circuit board includes a center light-emitting element area, a right-side light-emitting element area to the right of the center light-emitting element area, and a left-side light emitting element area to the left of the center light-emitting element area;
(b) the candle light-emitting elements are located in the center light-emitting element area; and
(c) one or more accent light-emitting elements are located in each of the right-side light-emitting element area and the left-side light-emitting element area and positioned to emit light through the display device front surface.

15. The gaming machine of claim 14 further including a number of additional driver circuits operatively connected to supply a respective driving signal to each light-emitting element located in the right-side light-emitting element area and the left-side light-emitting element area.

16. The gaming machine of claim 9 wherein:
(a) the display device includes a video display monitor that defines the display area; and
(b) the number of candle light-emitting elements comprise pixels of the video display monitor.

17. A method of providing gaming machine candle functions at a gaming machine, the method including:
(a) receiving a candle illumination state signal that defines a candle illumination state;
(b) in response to the candle illumination state signal, driving a number of candle light-emitting elements in accordance with the candle illumination state, the candle light-emitting elements being located in an upper peripheral area of a display device of the gaming machine, the display device having a display device front surface and defining a display area aligned with at least a portion of the display device front surface, wherein driving the number of candle light-emitting elements causes the number of candle light-emitting elements to emit light through the display device front surface; and
(c) simultaneously with driving the number of candle light-emitting elements, driving the display device to generate game graphics in at least a portion of the display area.

18. The method of claim 17 wherein driving the number of candle light-emitting elements includes directing a respective driving signal to each of the candle light-emitting elements under control of a driver controller operatively connected to a game processing system of the gaming machine.

19. The method of claim 18 wherein each of the candle light emitting elements comprises an RGB LED mounted on a circuit board in a location within the display device above the display area and wherein directing a respective driving signal to each of the candle light-emitting elements includes directing separate R, G, and B signals to the respective RGB LED along a signal path defined on the circuit board.

20. The method of claim 17 wherein each candle light-emitting element includes a respective pixel of a video display monitor included in the display device and driving the number of candle light-emitting elements includes directing a video signal to the video display monitor.
